(19) United States
(12) Patent Application Publication
(10) Pub. No.: US 2025/0377886 A1
(43) Pub. Date: Dec. 11, 2025

(54) METHOD, DEVICE, AND COMPUTER PROGRAM PRODUCT FOR MERGING PULL REQUEST

(71) Applicant: DELL PRODUCTS L.P., ROUND ROCK, TX (US)

(72) Inventors: Qiang YE, Chengdu (CN); Yongsheng GUO, Shanghai (CN); Mengze LIAO, Shanghai (CN); Fanliang LIN, Chengdu (CN); Hong DENG, Chengdu (CN); Qixiao LIU, Beijing (CN)

(21) Appl. No.: 18/790,163

(22) Filed: Jul. 31, 2024

(30) Foreign Application Priority Data
Jun. 7, 2024 (CN) 202410741099.4

(51) Int. Cl. G06F 8/71

(52) U.S. Cl. CPC G06F 8/71

(57) ABSTRACT

A method includes determining whether a code change associated with a pull request (PR) is related to a target object. The method further includes performing, in response to that the code change is related to the target object, a test associated with the target object on the PR. The method further includes avoiding, in response to that the code change is not related to the target object, performing the test associated with the target object on the PR. Through this method, it is possible to only perform a test associated with a target object on an extraction request related to the target object, without the need for performing a test associated with another object. Therefore, time and resource usage can be saved, the efficiency of merging a PR can be improved, and the energy consumption can be reduced.

### TECHNICAL FIELD

The present disclosure relates to the field of computers, and more particularly, to a method, device, and computer program product for merging a pull request (PR).

### BACKGROUND

A PR, also known as a merge request, is a common collaborative mechanism in an open-source community, and it may be used to implement functions such as code development, code review, project document management, error fixing, and version management. For example, a PR allows a developer to modify and develop code on a private branch thereof, and then initiates a PR to a maintainer of an original software system, requesting to merge his/her own code into a master branch.

An extraction request submitted by the developer needs to go through two build processes before being merged into the master branch: a PR build pipeline and a Master build pipeline. The PR build pipeline is a build process established for PRs, and is triggered when a PR is submitted, for quickly building and preliminarily testing the code requesting for merging, so that the developer and a reviewer can have an earlier understanding of a state of the code before merging. The PR build pipeline runs as a PR (per-PR) in the private branch without affecting the master branch. The master build pipeline is a build process established for the master branch for building and testing a plurality of PRs that have succeeded in a preliminary test and are to be merged into the master branch.

### SUMMARY OF THE INVENTION

Embodiments of the present disclosure relate to a method, device, and computer program product for merging a PR.

According to a first aspect of the present disclosure, a method for merging a PR is provided. The method includes: determining whether a code change associated with a pull request (PR) is related to a target object; performing, in response to that the code change is related to the target object, a test associated with the target object on the PR; and avoiding, in response to that the code change is not related to the target object, performing the test associated with the target object on the PR.

According to a second aspect of the present disclosure, an electronic device is provided. The electronic device includes at least one processor and a memory, wherein the memory is coupled to the at least one processor and has instructions stored thereon. The instructions, when executed by the at least one processor, cause the electronic device to perform the following: determining whether a code change associated with a pull request (PR) is related to a target object; performing, in response to that the code change is related to the target object, a test associated with the target object on the PR; and avoiding, in response to that the code change is not related to the target object, performing the test associated with the target object on the PR.

According to a third aspect of the present disclosure, a computer program product is provided. The computer program product is tangibly stored on a non-volatile computer-readable medium and includes machine-executable instructions, wherein the machine-executable instructions, when executed, cause a machine to perform the following: determining whether a code change associated with a pull request (PR) is related to a target object; performing, in response to that the code change is related to the target object, a test associated with the target object on the PR; and avoiding, in response to that the code change is not related to the target object, performing the test associated with the target object on the PR.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 shows a schematic diagram of an example environment in which a plurality of embodiments of the present disclosure can be implemented;

FIG. 2 shows a schematic diagram of another example environment in which a plurality of embodiments of the present disclosure can be implemented;

FIG. 3 shows a flow chart of a process for merging a PR according to some embodiments of the present disclosure;

FIG. 4 shows a schematic diagram of another process for merging a PR according to some embodiments of the present disclosure;

FIG. 5 shows a schematic diagram of a module relationship diagram of code modules according to some embodiments of the present disclosure;

FIG. 6 shows a schematic diagram of a work flow of a code correlation check engine according to some embodiments of the present disclosure;

FIG. 7 shows a schematic diagram of a process of adjusting a code correlation check engine according to some embodiments of the present disclosure;

FIG. 8 shows a pie chart of testing time saved by a process for merging a PR according to some embodiments of the present disclosure;

FIG. 9 shows a bar chart of a resource usage saved by a process for merging a PR according to some embodiments of the present disclosure;

FIG. 10 shows a data graph of partial build and test historical data of a PR according to some embodiments of the present disclosure; and

FIG. 11 is a block diagram of a device that can implement a plurality of embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

An extraction request submitted by a developer needs to go through two build processes before being merged into a master branch: a PR build pipeline and a Master build pipeline. The PR build pipeline is used for quickly running as a PR (per-PR) in a private branch, so as to build and preliminarily test code requesting for merging. The master build pipeline is used for building and testing (briefly referred to as a test hereinafter) a plurality of PRs that have succeeded in the preliminary test and are to be merged into the master branch. In the embodiments of the present disclosure, the test may include code build and/or code test, and the like.

With updates and upgrades of products for power protection data management, data storage, data protection, or the like, different products (also referred to as objects hereinafter) may have the same underlying code, only upper-level code is improved, and therefore they have a common code repository. For example, a new object (also referred to as a target object or a second object hereinafter) and a current object (also referred to as a first object hereinafter) may have a common code repository to include common code, but have corresponding additional code repositories to include specific code.

In this case, when a PR is proposed by a developer, it first goes through the PR build pipeline to build and test specific code for different objects, and then enters the master build pipeline to usually build and test common code. The PR build pipeline typically consumes more resources and time (for example, 5 to 10 times) than the master build pipeline. When a developer submits a PR, the PR needs to go through build and test for different objects in the PR build pipeline, which consumes a lot of resources and time. Therefore, an effective method for merging a PR is needed.

To this end, the embodiments of the present disclosure provide a solution for merging a PR. In the embodiments of the present disclosure, it may be determined whether a code change associated with a PR is related to a target object. If the code change is related to the target object, a test associated with the target object is performed on the PR. If the code change is not related to the target object, it is avoided to perform the test associated with the target object.

Through this method, it is possible to only perform a test associated with a target object on an extraction request related to the target object, without the need for performing a test associated with another object, which effectively saves time and resource usage, so that the efficiency of merging a PR can be improved, and the energy consumption can be reduced. Please note that the target object herein may also be referred to as a new object, which is updated and upgraded based on the current object. In the embodiments herein, the object may include products for power protection data management, data storage, or data protection, such as storage devices.

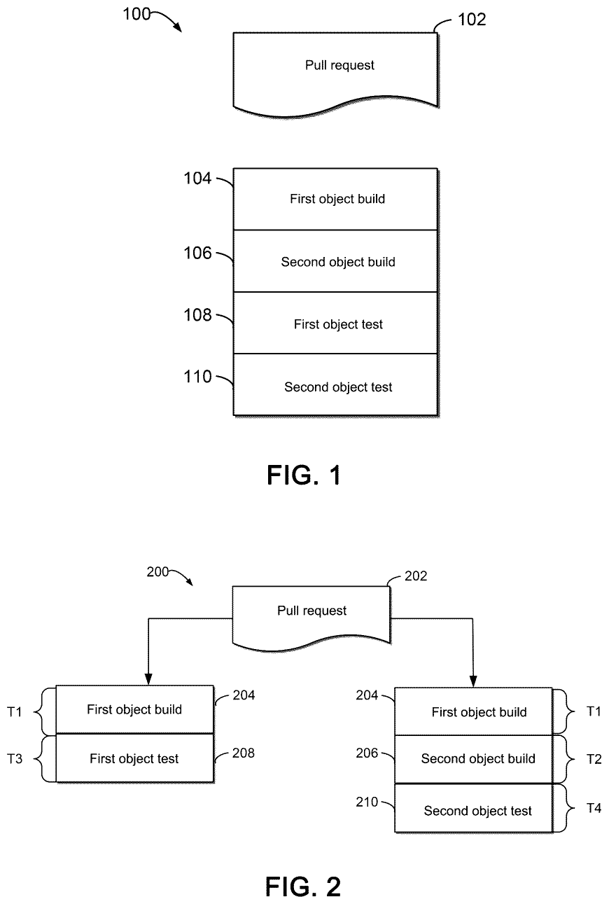

FIG. 1 shows a schematic diagram of an example environment 100 in which a plurality of embodiments of the present disclosure can be implemented. As shown in FIG. 1, a new object (that is, a second object) may include the same code (that is, common code) as a current object (that is, a first object) and its specific code. It should be understood that the first and second objects here are only provided as examples and may include any number of new objects and current objects. For example, the common code may include a first object build 104, the specific code of the new object includes a second object build 106 and a second object test 110, and the specific code of the current object includes a first object test 108. In some embodiments, the first object may be a current storage product, and the second object may be a next-generation storage product.

As shown in FIG. 1, running the first object build 104, the second object build 106, the first object test 108, and the second object test 110 costs time T1, T2, T3, and T4, respectively. In the embodiment shown in FIG. 1, when a PR 102 is submitted, the first object build 104, the second object build 106, the first object test 108, and the second object test 110 are run in series to test a code change in the PR 102 and merge it into a master branch.

For the new object, the test time for merging the PR 102 into the master branch is T1+T2+T3+T4. For the current object, the test time for merging the PR 102 into the master branch is T1+T3. Therefore, due to the product version update, the additional test time spent on each PR is T2+T4. In some embodiments, in a solution of running the test for the new object and the test for the current object in a serial manner, the additional time spent due to the product version update is 40 minutes (44%).

FIG. 2 shows a schematic diagram of an example environment 200 in which a plurality of embodiments of the present disclosure can of be implemented. As shown in FIG. 2, when a PR 202 is submitted, a test for a first object and a test for a second object are run in parallel to test a code change in the PR 202 to merge it into a master branch. The test for the first object includes a first object build 204 and a first object test 208, and the test for the second object includes the first object build 204, a second object build 206, and a second object test 210. It should be understood that the first object build 204 belongs to common code, and therefore, it needs to be run for both the current object and the new object.

In the embodiment of FIG. 2, for the new object, the test time for merging the PR 102 into the master branch is T1+T2+T4. For the current object, the test time for merging the PR 102 into the master branch is T1+T3. Therefore, due to the product version update, the additional test time spent on each PR is T2+T4−T3. In some embodiments, in a solution of running the test for the new object and the test for the current object in a parallel manner, the additional time spent due to the product version update is 35 minutes (39%). By using the parallel method, only the common code test and the new object test are performed on the PR, without the need for performing the current object test, thereby saving time compared with the serial method.

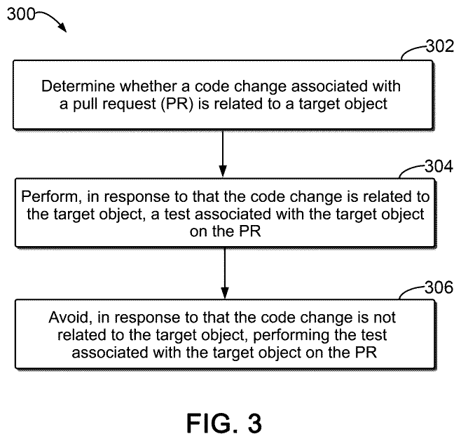

FIG. 3 shows a schematic diagram of a process 300 for merging a PR according to some embodiments of the present disclosure. At 302, it is determined whether a code change associated with a PR is related to a target object. In some embodiments, it is determined whether a code change associated with the PR 102/202 is associated with a new object. At 304, in response to that the code change is related to the target object, a test associated with the target object is performed on the PR. In some embodiments, if the code change contained in the PR 102 is associated with a new object, tests associated with the new object, namely, the second object build 106/206 and the second object test 110/210, are run.

At 306, in response to that the code change is not related to the target object, there is no need to perform the test associated with the target object on the PR. In some embodiments, if the code change contained in the PR 102 is associated with a new object, there is no need to run the second object build 106/206 and the second object test 110/210. In some embodiments, it may be necessary to run tests for a current object, such as the first object build 104/204 and the first object test 108/208. In some embodiments, the PR unrelated to the target object may be delivered to a master build pipeline without passing through any PR build pipeline. In some embodiments, the PR unrelated to the target object may be merged into a master branch. For example, merging the PR into the master branch may include performing a test associated with the master branch on the PR in the master build pipeline.

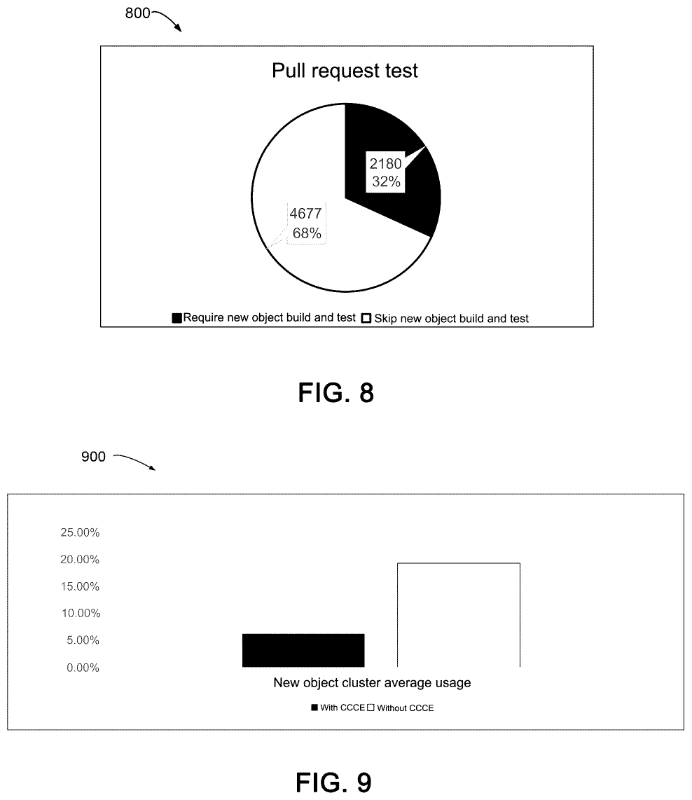

Through the process 300, build and test associated with the new object can be performed only for an extraction request related to the new object, without the building and testing associated with the current object, thereby effectively saving time and resource usage, which can improve the merge efficiency and reduce the energy consumption. The example technical effects of the process 300 will be described in detail below according to FIG. 8 to FIG. 10.

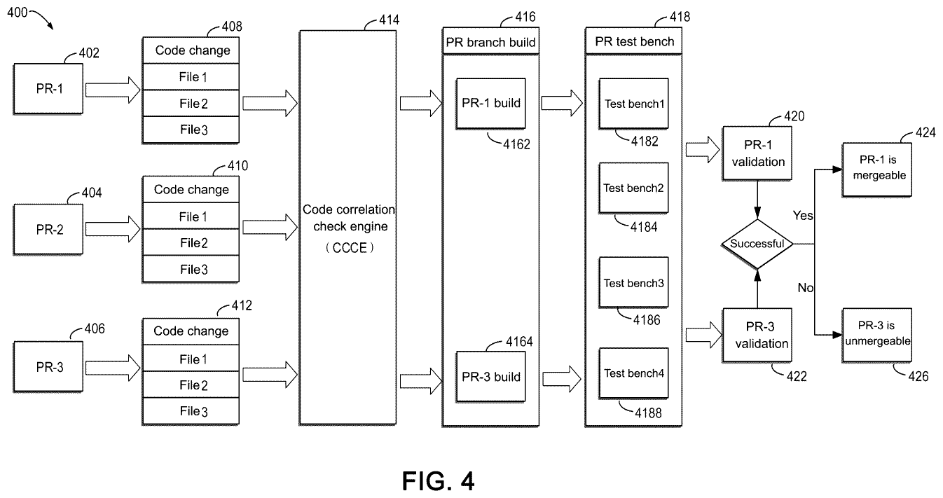

FIG. 4 shows a schematic diagram of a process 400 for merging a PR according to some embodiments of the present disclosure. In the process 400, there are three PRs, a PR-1 402 and a PR-3 406 are related to a new object, and a PR-2 404 is not related to the new object. The PR-1 402, the PR-2 404, and the PR-3 406 respectively include code changes 408, 410, and 412, and the code changes 408 to 412 respectively include different files or code modules (also referred to as modules). It should be understood that in this article, the PR being related to an object refers to that the file or module included in the code change in the PR is related to the object.

The code changes 408 to 412 of the PRs, that is, RP-1 402 to PR-3 406, are respectively fed to a Code Correlation Check Engine (CCCE) 414. The CCCE 414 may detect whether the PR is related to the new object, and deliver the PR-1 402 and the PR-3 406 related to the new object to a PR branch build platform 416 and a PR test bench 418 for performing a PR-1 validation 420 and a PR-3 validation 422, thereby determining whether the PR-1 or the PR-3 can be merged to a master branch. For example, the PR-1 402 goes through a PR-1 build 4162 and a test bench 1 4182, and the PR-3 406 goes through a PR-3 build 4164 and a test bench 4 4188. As shown in FIG. 4, if the PR-1 validation 420 is successful, it is determined at 424 that the PR-1 402 is mergeable, and the PR-1 402 is merged into the master branch. If the PR-3 validation 422 is not successful, it is determined at 426 that the PR-3 422 is unmergeable, and the PR-3 422 is returned to a submitter for repair until the PR-3 422 can be merged into the master branch.

As shown in FIG. 4, the PR-2 404 is not related to the new object, and therefore, the test associated with the new object is avoided from being performed on the PR-2 404. For example, the PR-2 404 may directly enter the master build pipeline to be merged into the master branch without the need for build and test, thereby saving the PR branch build platform 416, the PR test bench 2 4184, and the PR test bench 3 4186, and thus saving the power consumption. In some embodiments, the PR-2 404 may undergo the test related to the master branch in the master build pipeline.

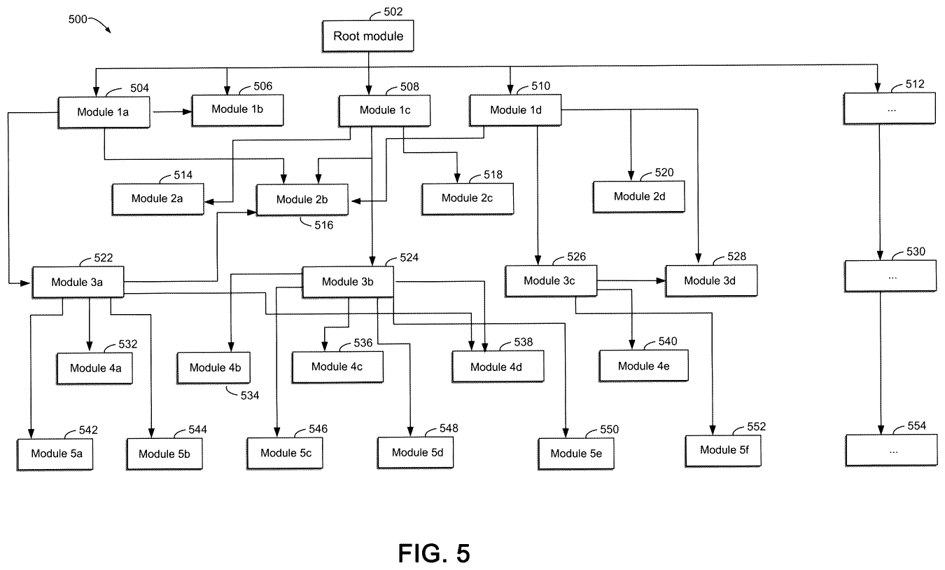

FIG. 5 shows a schematic diagram of a module relationship diagram 500 of code modules according to some embodiments of the present disclosure. For example, the module relationship diagram may be a directed acyclic graph that reflects reference relationships between code modules of a new object. For example, the module relationship diagram 500 may be used by a CCCE to determine whether a code module is related to a new object. As shown in FIG. 5, a root module 502 associated with a software system of the new object may be first created, which is usually a foundation or starting module of the entire system. In some embodiments, the root module of the system may be created by a software developer, and modules of the next level depended on by the root module may be configured by the software developer.

In some embodiments, the root module 502 of the new object may be determined as the first level of the module relationship diagram. According to a configuration file of the root module 502, downstream modules 504 to 512 depended on by the root module 502 are acquired to be regarded as the second level of the module relationship diagram. According to the configuration files of the corresponding downstream modules 504 to 512, further downstream modules 514 to 520 depended on by the downstream modules 504 to 512 are determined to be regarded as the next level of the module relationship diagram. For example, by sequentially regarding the modules depended on by the modules in the next level as a further next level until reaching modules 542 to 554 at the lowest level, the module relationship diagram of the new object is created. The module at the lowest level is a public module that does not have a referenced module. It should be understood that the number of levels and the number of modules at each level in FIG. 5 are only shown as examples. The module relationship diagram may include any number of levels, and each level may include any number of modules.

In some embodiments, the new object may be a Java-based product and directly utilize a Maven pom file of the root module to generate a directed acyclic graph. In some embodiments, downstream modules depended on by each module may be manually queried, and a directed acyclic graph may be generated according to reference relationships between the modules.

In some embodiments, a directed acyclic graph may be used to determine a distance D between a module and the root module 502 as well as a count Ci of the module being depended on by other modules. It should be understood that the distance D is the shortest distance between the module and the root module. For example, the modules 504 to 512 at the first level have a distance D=1 from the root module 502, the modules 514 to 520 at the second level have a distance D=2 from the root module 502, the modules 522 to 530 at the third level have a distance D=3 from the root module 502, and so on. In FIG. 5, the modules 542 to 554 at the lowest level have a distance D=5 from the root module 502. It should be understood that the number of levels in FIG. 5 is only shown as an example, and the present disclosure is not limited to this.

In FIG. 5, it is assumed that the count of a module i being depended on by other modules is Ci, and the total number of modules having the same distance from the module i, that is, the modules at the same level, is n. The count of a module being depended on by other modules may also be referred to as be depended on count. For example, the count of a module being depended on is equal to the sum of the numbers of arrows that reach and come from the module in the module relationship diagram. For example, the count of the module 508 being depended on is C1c=5, the count of the module 546 at the lowest level being depended on is C5c=1, and so on. For example, in FIG. 5, for the module 508 at the second level, n=4. It should be understood that the be depended on count of the module and the number of modules in each level in FIG. 5 are only shown as an example, and the present disclosure is not limited to this.

In some embodiments, a correlation score of a corresponding module is determined based on a distance between the corresponding module and the root module in the module relationship diagram and the count of the corresponding module being depended on by other modules. For example, the correlation score of a module may be calculated according to Equation 1:

$$Correlation Score of Module = min \{ 200 \times ( W 1 \times \frac{1}{D} + W 2 \times \frac{{C}_{i}}{1 + {C}_{1} + {C}_{2} + … + {C}_{n}} ) , 100 \} \qquad Equation 1$$

wherein min represents the minimum value between the two, W1 represents a weight of a distance term (also known as a first weight), W2 represents a weight of a be depended on count term (also known as a second weight), D is the shortest distance between the module and the root module, Ci is the be depended on count of the i-th module, and n is the number of modules having the same distance from the root module as the module Ci, that is, the number of modules at the same level as the module Ci.

In some embodiments, the correlation score of the module may be compared with a threshold to determine whether the module is related to a new object. In some embodiments, when the correlation score of the module is greater than the threshold, the module is related to the new object, and when the correlation score of the module is less than or equal to the threshold, the module is not related to the new object. For example, the threshold may be 50, and the first weights W1 and W2 are both equal to 0.5. It should be understood that W1 and W2 may be adjusted as long as their sum is 1.

In some embodiments, if a distance of a second level module is D=2, the be depended on count is Ci=10, and the total be depended on count of modules having the same distance (that is, the second level) as the module is 1+C1+C2+ . . . +Cn=40, the correlation score of the module is 200×(0.5×½+0.5× 10/40)=75>50, and therefore, the module is related to the new object.

In some embodiments, if for a certain module at the lowest level, D=3, the be depended on count is Ci=1, and the total be depended on count of modules having the same distance (that is, the lowest level) as the module is 1+C1+C2+ . . . +Cn=100, the correlation score of the module is 200×(0.5×⅓+0.5× 1/100)=34.3<50, and therefore, the module is not related to the new object.

In some embodiments, the module included in the code change in the PR may be detected, and a correlation score of the corresponding module may be calculated to determine whether the PR is related to the first module. In some embodiments, if the PR includes a module having a correlation score greater than a threshold, it may be determined that the PR is related to the target object. If the correlation scores of the modules included in the PR are all less than or equal to the threshold, it may be determined that the PR is not related to the target object. In other words, if the PR does not include any module having a correlation score greater than the threshold, it may be determined that the PR is not related to the target object.

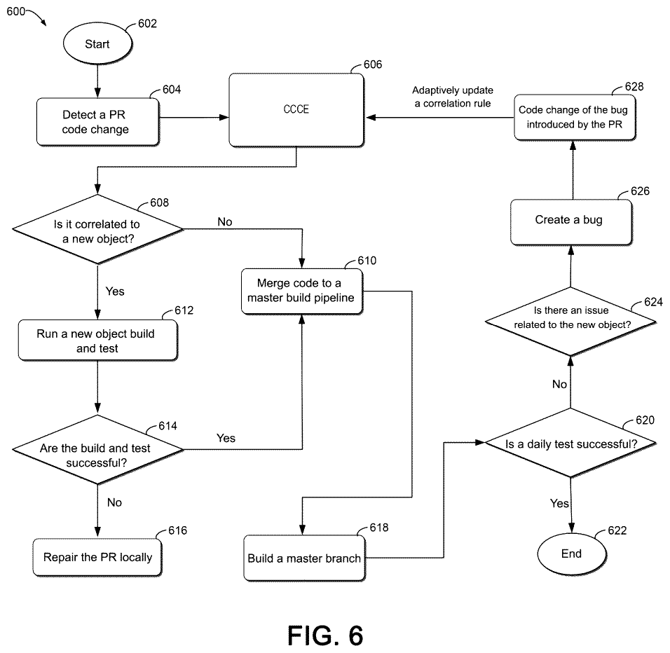

FIG. 6 shows a schematic diagram of a work flow 600 of a code correlation check engine according to some embodiments of the present disclosure. In order to better describe the process 600, the description is made here with reference to the example process 400 described in FIG. 4.

At 602, the process starts. At 604, a code change in a PR is detected to determine whether the PR is proposed. For example, code changes 408 to 412 in a PR-1 402 to a PR-3 406 are detected. In some embodiments, if a code change is detected in a PR, a module of the code change is input to a CCCE 414 at 606.

At 608, the CCCE determines whether the PR is related to a new object. The module included in the code change in the PR may be detected, and a correlation score of the corresponding module may be calculated according to the Equation 1 above to determine whether the PR is related to the new object. If it is determined that the PR is not related to the new object (for example, a PR-2 404), at 610, code of the PR PR-2 404 is merged into a master build pipeline. In some embodiments, the code merging 610 may include performing a test different from 608 on the PR in the master build pipeline, such as a test related to a current object.

If it is determined that the PR is related to a new object (such as the PR-1 402 or the PR-3 406), at 612, tests associated with the new object, such as a new object build and test, are performed. At 614, it is determined whether the PR succeeds in the new object build and test. If it succeeds, at 610, the code of the PR (for example, the PR-1 402) is merged into the master build pipeline, and at 618, the code is merged from the master build pipeline into a master branch to build the master branch 612. If the PR fails the test (for example, the PR-3 406), at 616, the PR is repaired locally until it can be merged into the master branch.

Through the above method, build and test associated with the new object can be performed only for an extraction request related to the new object, without the need for performing build and test associated with other products, thereby effectively saving time and resource usage, which can improve the merge efficiency and reduce the energy consumption.

At 620, a daily test is performed on the master branch to determine whether it succeeds in the daily test. In some embodiments, the daily test includes performing a test on the new code or the PR that is merged into the master branch during a specific time period, so as to immediately find a bug in the new code. If it succeeds in the daily test, the process ends at 622. If it fails in the daily test, it is detected whether there is any issue related to the new object at 624. At 626, a bug associated with the issue is created. Then, at 628, a code change of the bug introduced by the PR is detected. According to the code change, a correlation rule is adaptively updated to adaptively adjust the CCCE 414.

In some embodiments, the correlation rule may include calculating a correlation score of a code module in the PR and comparing the correlation score with a threshold. In some embodiments, if the PR includes a module having a correlation score greater than a threshold, it may be determined that the PR is related to the target object. If the correlation scores of the modules included in the PR are all less than or equal to the threshold, it may be determined that the PR is not related to the target object.

In some embodiments, if the PR includes a module having a correlation score less than or equal to a threshold, it may be determined that the PR is related to the target object. If the correlation scores of the modules included in the PR are all greater than the threshold, it may be determined that the PR is not related to the target object.

In some embodiments, detecting the bug related to the new object in the master branch may indicate the presence of a module that is not detected by the CCCE and is related to the new object. Therefore, it is expected that the CCCE can adjust the code correlation rule to include these modules. In some embodiments, the threshold may be adjusted to include more modules related to the new object. For example, the threshold may be increased or decreased to include more related modules. In some embodiments, values of a first weight and a second weight may be adjusted to include more modules related to the new object. For example, including more modules related to the new object may increase the detection range of 608, thereby improving the accuracy.

Through the above embodiments, the CCCE may be adaptively updated according to the code change introduced by the PR and related to the new object, thereby covering the module associated with the bug, improving the accuracy of the correlation detection of the CCCE, thereby improving the accuracy of merging the PR and avoiding the introduction of the bug in the master branch.

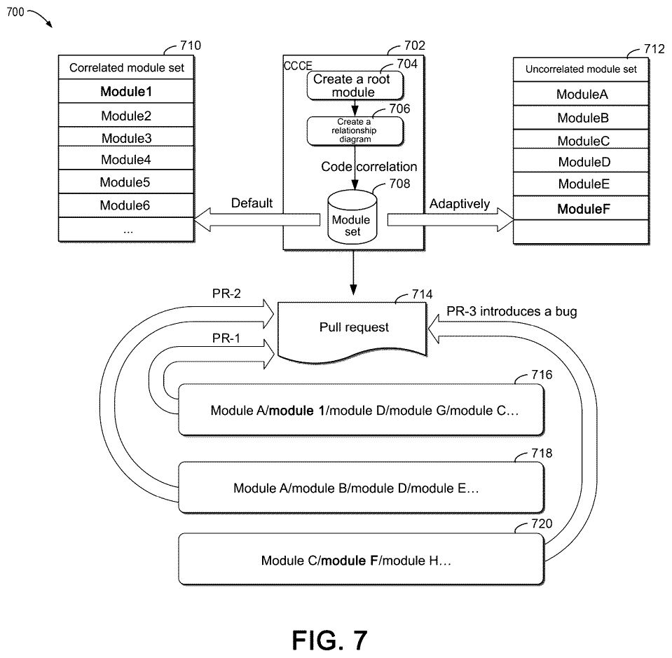

FIG. 7 shows a schematic diagram of a process 700 of adjusting a CCCE according to some embodiments of the present disclosure. For ease of understanding, the process 700 will be described below with reference to the example process 600 in FIG. 6.

As shown in FIG. 7, a CCCE 702 may create a root module 704 of a software system associated with a new object, and create a module relationship diagram 706 of the software system associated with the new object, as described above with reference to FIG. 5.

Then, the CCCE 702 may determine a correlated module set according to the correlation between each module in the module relationship diagram and the new object. For example, at 708, the module set is determined and classified into a correlated module set 710 and an uncorrelated module set 712 according to their responsiveness scores. In some embodiments, a correlation score of a corresponding module may be determined based on a distance between the corresponding module and the root module in the module relationship diagram and the count of the corresponding module being depended on by other modules, as described in FIG. 5 above. For example, the correlation score of the corresponding module may be determined according to the Equation 1 above.

In some embodiments, the correlation scores of various modules are compared with the threshold to determine whether the corresponding module is related to the new object, and the modules related to the new object are determined as the correlated module set 710. For example, modules having correlation scores greater than the threshold may be combined into the correlated module set 710, and modules having correlation scores less than or equal to the threshold may be combined into the uncorrelated module set 712.

As shown in FIG. 7, the default correlated module set 710 may include a module 1, a module 2, a module 3, and so on, and the uncorrelated module set 712 may include a module A, a module B, and so on. For example, the correlated module set 710 may include a code module 1, a module 2, a module 3, and so on related to the new object. When a PR 714 is submitted, a code change, that is the code module, in the PR 714 is detected.

In some embodiments, it may be detected whether the PR is related to a new object (for example, 608) as follows. For example, if it is detected that a PR-1 716 includes the module 1 belonging to the correlated module set 710, it is determined that the PR-1 716 is related to the new object, and a test 614 related to the new object is required. For example, if it is detected that all modules included in a PR-2 718 do not belong to the correlated module set 710, it is determined that the PR-2 718 is not related to the new object. The test related to the new object may be skipped, and code merging 610 may be performed.

In some embodiments, if it is detected in step 608 that all modules included in a PR-3 720 do not belong to the correlated module set 710, it is determined that the PR-3 720 is not related to the new object, the code merging 610 is performed, and the master branch is constructed 618. However, at 620, the master branch fails the daily test, and at 624, it is detected that the PR-3 720 has an issue related to the new object; and through steps 626 and 628, it is found that the bug causing the issue is a module F. Therefore, it is expected to adaptively adjust the CCCE so that the module F is included in the correlated module set 710.

As shown in FIG. 7, it is detected whether the PR 714 introduces a bug in the master branch. For example, it is detected that a bug is introduced in the PR-3 720. Then, it is detected whether the bug is associated with the new object, and in response to the bug in the PR PR-3 720 being related to the new object, the correlated module set 710 is adjusted to include the module F associated with the bug.

In some embodiments, the correlated module set 710 may be adjusted by adjusting a first weight W1 and a second weight W2, wherein the first weight W1 corresponds to the distance between the module and the root module, and the second weight W2 corresponds to the count of the module being depended on by other modules, thereby adjusting the correlated module set 710 to include the module F.

In some embodiments, the threshold may be reduced to increase the number of code modules included in the correlated module set 710, so as to adjust the correlated module set 710. For example, the threshold may be adjusted from 50 to 48, 47, and so on. In some embodiments, the added code modules may include underlying modules in the module relationship diagram, and the underlying modules are common code related to the target object. The underlying modules are also referred to as modules at the lowest level herein, such as the modules 542 to 554 in FIG. 5. For example, the module F may be one of the modules 542 to 554 in FIG. 5. It should be understood that the underlying modules are basic and common modules in the software system of the new object, and therefore, they may have a high be depended on count, resulting in a high correlation score.

Through the process 700, it may be determined whether a PR is associated with a new object by defining the correlated module set 710 and comparing modules in the PR 714 with the correlated module set 710, without the need to calculate the correlation score for each module in the PR. Therefore, the efficiency of correlation detection may be further improved and time can be saved.

In addition, through the process 700, the correlated module set 710 may be adaptively adjusted to cover the module F that causes the master branch bug and is not detected. The CCCE may be adaptively updated to improve the accuracy of correlation detection and PR merging, thereby avoiding the introduction of errors in the master branch.

FIG. 8 shows a pie chart 800 of time saved by the process 300 for merging a PR according to some embodiments of the present disclosure. As shown in pie chart 800, from Nov. 1, 2023 to Jan. 1, 2024, only 32% of PRs (2180 PRs) experienced build and test associated with new objects, and 68% of the PRs (4677 PRs) skipped build and test associated with new objects.

Compared with the serial method, the process of merging a PR according to some embodiments of the present disclosure may further save 3118 hours of PR build and test time. Compared with the parallel method, the process of merging a PR according to some embodiments of the present disclosure may further save 2728 hours (68%) of PR build and test time. As can be seen, the process of merging a PR according to some embodiments of the present disclosure greatly improves the efficiency of merging and saves time.

FIG. 9 shows a bar chart 900 of a resource usage saved by a process for merging a PR according to some embodiments of the present disclosure. It should be understood that the resources here may include hardware resources such as the PR branch build platform 416 and the PR test bench 418 as described in FIG. 4, which may also be referred to as a new object cluster. It should be understood that the resource usage may be defined as a ratio of devices used for build and test to all the devices.

As shown in the bar chart 900, from Nov. 1, 2023 to Jan. 1, 2024, if the code correlation check module engine is used, the average usage of the new object cluster is 6.2%. If the code correlation check module engine is used, the average usage of the new object cluster is 6.2% * 32%=19.3%. Compared with the serial method or the parallel method, the process of merging a PR according to some embodiments of the present disclosure may further save 13.1% of new object cluster (hardware resources). As can be seen, the process of merging a PR according to some embodiments disclosed in the present disclosure effectively saves the hardware resources and reduces the energy consumption.

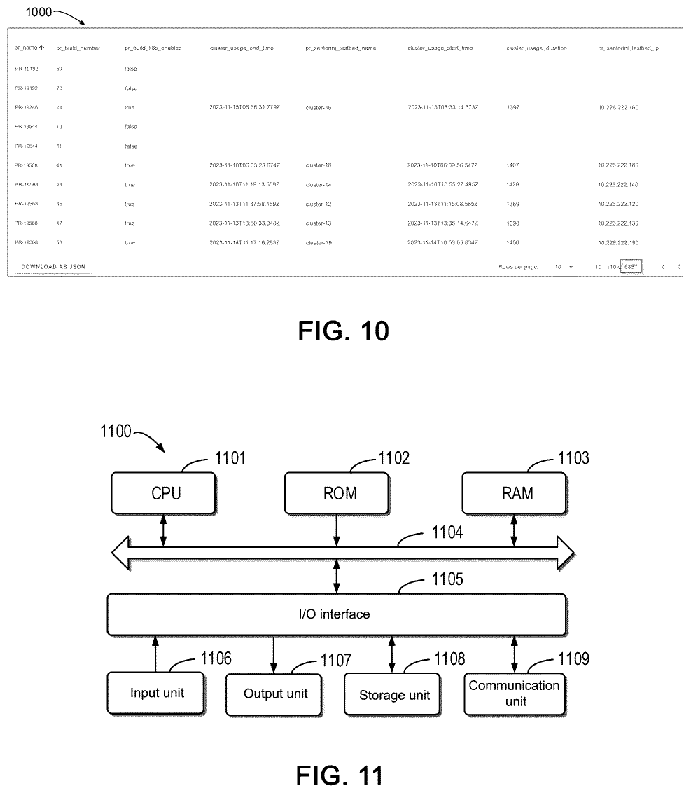

FIG. 10 shows a chart 1000 of partial build and test historical data of a PR according to some embodiments of the present disclosure. The first column of the chart 1000 represents the name of the PR, the second column represents the number of code builds for the PR, the third column represents whether to perform build and test associated with a new object on the PR, the fourth column represents the end time of cluster usage, the fifth column represents the name of the test bench, the sixth column represents the start time of cluster usage, the seventh column represents the duration of cluster usage, and the eighth column represents an ip of the test bench.

The chart 1000 shows the build and test example data of 10 PRs in 6857 PRs. The first, second, fourth, and fifth PRs are not related to the new object, and therefore, the tests associated with the new object (such as new object build and test) are skipped. Other PRs are related to the new object, and therefore, the tests associated with the new object (such as new object build and test) are performed. As can be seen, the process of merging a PR according to the embodiments of the present disclosure can save time and resource usage.

FIG. 11 shows a schematic block diagram of an example device 1100 that may be used to implement an embodiment of the present disclosure. As shown in the figure, the device 1100 includes a computation unit 1101 that can perform various appropriate actions and processing according to computer program instructions stored in a Read-Only Memory (ROM) 1102 or loaded from a storage unit 1108 into a Random Access Memory (RAM) 1103. Various programs and data required for the operation of the device 1100 may also be stored in the RAM 1103. The computation unit 1101, the ROM 1102, and the RAM 1103 are connected to each other through a bus 1104. An Input/Output (I/O) interface 1105 is also connected to the bus 1104.

A plurality of components in the device 1100 are connected to the I/O interface 1105, including: an input unit 1106, such as a keyboard and a mouse; an output unit 1107, such as various types of displays and speakers; the storage unit 1108, such as a magnetic disk and an optical disc; and a communication unit 1109, such as a network card, a modem, and a wireless communication transceiver. The communication unit 1109 allows the device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. The computation unit 1101 executes various methods and processes described above, such as the method 300. For example, in some embodiments, the method 300 may be implemented as a computer software program that is tangibly included in a machine-readable medium, such as the storage unit 1108. In some embodiments, part or all of the computer program may be loaded and/or installed to the device 1100 via the ROM 1102 and/or the communication unit 1109. When the computer program is loaded to the RAM 1103 and executed by the computation unit 1101, one or more steps of the method 300 described above may be performed. Alternatively, in other embodiments, the computation unit 1101 may be configured to implement the method 300 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium.

The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for merging a pull request (PR), comprising:
determining whether a code change associated with the PR is related to a target object;
performing, in response to that the code change is related to the target object, a test associated with the target object on the PR; and
avoiding, in response to that the code change is not related to the target object, performing the test associated with the target object on the PR.

2. The method according to claim 1, wherein determining whether the PR is related to the target object comprises:
determining a correlated module set comprising a code module related to the target object;
determining whether the PR comprises a module in the correlated module set;
determining, in response to that the PR comprises the module in the correlated module set, that the PR is related to the target object; and
determining, in response to that the PR does not comprise the module in the correlated module set, that the PR is not related to the target object.

3. The method according to claim 2, wherein determining the correlated module set comprises:
determining, based on a distance between a corresponding module and a root module in a module relationship diagram and a count of the corresponding module being depended on by another module, a correlation score of the corresponding module, wherein the module relationship diagram comprises a module associated with the target object;
comparing the correlation score with a threshold to determine whether the corresponding module is related to the target object; and
determining the module related to the target object as the correlated module set.

4. The method according to claim 3, further comprising:
merging the PR that succeeds in the test and the PR that avoids the test into a master branch;
detecting whether the PR introduces a bug in the master branch;
detecting whether the bug is associated with the target object; and
adjusting, in response to the bug in the PR being related to the target object, the correlated module set to comprise a module associated with the bug.

5. The method according to claim 4, wherein adjusting the correlated module set comprises:
adjusting a first weight and a second weight to adjust the correlated module set, wherein the first weight corresponds to the distance between the module and the root module, and the second weight corresponds to the count of the module being depended on by another module.

6. The method according to claim 4, wherein adjusting the correlated module set comprises:
reducing the threshold to increase the number of code modules comprised in the correlated module set.

7. The method according to claim 6, wherein the added code module comprises an underlying module in the module relationship diagram, and the underlying module is common code related to the target object.

8. The method according to claim 3, wherein the module relationship diagram of the target object is created as follows:
determining the root module of the target object as a first level of the module relationship diagram;
acquiring, according to a configuration file of the root module, a downstream module depended on by the root module as a second level of the module relationship diagram; and
determining, according to a configuration file of the corresponding downstream module, a further downstream module depended on by the downstream module as a next level of the module relationship diagram.

9. The method according to claim 1, wherein determining whether the PR is related to the target object further comprises:
determining a corresponding module in the PR;
determining a correlation score of the corresponding module in the PR based on a distance between the corresponding module in the PR and the root module in the module relationship diagram as well as the count of the corresponding module being depended on by another module, wherein the module in the PR comprises the code change; and
comparing the correlation score of the corresponding module of the PR with a threshold to determine whether the PR is related to the target object.

10. The method according to claim 9, wherein determining whether the PR is related to the target object comprises:
determining that the PR is related to the target object in response to that the PR comprises the module of which the correlation score is greater than the threshold; and
determining that the PR is not related to the target object in response to that the correlation scores of the modules comprised in the PR are all less than or equal to the threshold.

11. The method according to claim 1, further comprising:
repairing the PR in response to the PR failing the test until the PR is capable of being merged into a master branch.

12. An electronic device, comprising:
at least one processor; and
a memory coupled to the at least one processor and having instructions stored thereon, wherein the instructions, when executed by the at least one processor, cause the electronic device to perform following operations:
determining whether a code change associated with a pull request (PR) is related to a target object;
performing, in response to that the code change is related to the target object, a test associated with the target object on the PR; and
avoiding, in response to that the code change is not related to the target object, performing the test associated with the target object on the PR.

13. The electronic device according to claim 12, wherein determining whether the PR is related to the target object comprises:
determining a correlated module set comprising a code module related to the target object;
determining whether the PR comprises a module in the correlated module set;
determining, in response to that the PR comprises the module in the correlated module set, that the PR is related to the target object; and
determining, in response to that the PR does not comprise the module in the correlated module set, that the PR is not related to the target object.

14. The electronic device according to claim 13, wherein determining the correlated module set comprises:
determining, based on a distance between a corresponding module and a root module in a module relationship diagram and a count of the corresponding module being depended on by another module, a correlation score of the corresponding module, wherein the module relationship diagram comprises a module associated with the target object;
comparing the correlation score with a threshold to determine whether the corresponding module is related to the target object; and
determining the module related to the target object as the correlated module set.

15. The electronic device according to claim 14, wherein the operations further comprise:
merging the PR that succeeds in the test and the PR that avoids the test into a master branch;
detecting whether the PR introduces a bug in the master branch;
detecting whether the bug is associated with the target object; and
adjusting, in response to the bug in the PR being related to the target object, the correlated module set to comprise a module associated with the bug.

16. The electronic device according to claim 15, wherein adjusting the correlated module set comprises:
adjusting a first weight and a second weight to adjust the correlated module set, wherein the first weight corresponds to the distance between the module and the root module, and the second weight corresponds to the count of the module being depended on by another module.

17. The electronic device according to claim 15, wherein adjusting the correlated module set comprises:
reducing the threshold to increase the number of code modules comprised in the correlated module set.

18. The electronic device according to claim 14, wherein the module relationship diagram of the target object is created as follows:
determining the root module of the target object as a first level of the module relationship diagram;
acquiring, according to a configuration file of the root module, a downstream module depended on by the root module as a second level of the module relationship diagram; and
determining, according to a configuration file of the corresponding downstream module, a further downstream module depended on by the downstream module as a next level of the module relationship diagram.

19. The electronic device according to claim 12, wherein determining whether the PR is related to the target object further comprises:
determining a corresponding module in the PR;
determining a correlation score of the corresponding module in the PR based on a distance between the corresponding module in the PR and the root module in the module relationship diagram as well as the count of the corresponding module being depended on by another module, wherein the module in the PR comprises the code change; and
comparing the correlation score of the corresponding module of the PR with a threshold to determine whether the PR is related to the target object.

20. A computer program product, the computer program product being tangibly stored on a non-volatile computer-readable medium and comprising machine-executable instructions, wherein the machine-executable instructions, when executed, cause a machine to perform the following:
determining whether a code change associated with a pull request (PR) is related to a target object;
performing, in response to that the code change is related to the target object, a test associated with the target object on the PR; and
avoiding, in response to that the code change is not related to the target object, performing the test associated with the target object on the PR.
